(19) United States
(12) Patent Application Publication
(10) Pub. No.: US 2017/0282870 A1
(43) Pub. Date: Oct. 5, 2017

(54) VEHICLE TRAILER PARKING BRAKE

(71) Applicant: GM GLOBAL TECHNOLOGY OPERATIONS LLC, Detroit, MI (US)

(72) Inventors: GRANT L. MEADE, WHITBY (CA); NORMAN J. WEIGERT, WHITBY (CA); VYACHESLAV BEREZIN, NEWMARKET (CA)

(73) Assignee: GM GLOBAL TECHNOLOGY OPERATIONS LLC, Detroit, MI (US)

(21) Appl. No.: 15/086,779

(22) Filed: Mar. 31, 2016

(51) Int. Cl. B60T 8/17; F16D 65/18

(52) U.S. Cl. CPC B60T 8/1708; F16D 65/18

(57) ABSTRACT

Methods and systems are provided for controlling braking for a trailer that is connected to a vehicle. In accordance with one embodiment, a trailer includes a connector, a parking brake, an actuator, and a processor. The connector is configured to connect the trailer to a vehicle. The parking brake is disposed onboard the trailer. The actuator is coupled to the parking brake. The processor is configured to cause the actuator to engage the parking brake in accordance with engagement instructions provided from the vehicle to the trailer.

### TECHNICAL FIELD

The present disclosure generally relates to vehicles, and more particularly relates to a parking brake for a trailer for a vehicle.

### BACKGROUND

Various trailers are manufactured today for use in connection with vehicles. Typically the vehicle is connected to the trailer, and then transports the trailer along with the vehicle as the vehicle is driven. However, in certain instances it may be desirable to provide improved braking of trailers when connected to a vehicle.

Accordingly, it is desirable to provide improved techniques for providing braking for vehicle trailers. It is also desirable to provide methods and systems utilizing such techniques. Furthermore, other desirable features and characteristics of the present invention will be apparent from the subsequent detailed description and the appended claims, taken in conjunction with the accompanying drawings and the foregoing technical field and background.

### SUMMARY

In accordance with an exemplary embodiment, a system is provided. The system comprises a parking brake, an actuator, and a processor. The parking brake is configured to be installed on a trailer that is configured to be connected to a vehicle. The actuator is coupled to the parking brake. The processor is configured to be installed on the trailer, and is configured to cause the actuator to engage the parking brake in accordance with engagement instructions provided from the vehicle to the trailer.

In accordance with another exemplary embodiment, a trailer is provided. The trailer includes a connector, a parking brake, an actuator, and a processor. The connector is configured to connect the trailer to a vehicle. The parking brake is disposed onboard the trailer. The actuator is coupled to the parking brake. The processor is configured to cause the actuator to engage the parking brake in accordance with engagement instructions provided from the vehicle to the trailer.

In accordance with a further exemplary embodiment, a method is provided. The method comprises receiving engagement instructions from a vehicle to a trailer for engagement of a parking brake of the trailer, wherein the trailer is connected to the vehicle, and, in response to the engagement instructions, causing an actuator on the trailer to engage a parking brake of the trailer in tandem with a separate parking brake of the vehicle.

### DESCRIPTION OF THE DRAWINGS

The present disclosure will hereinafter be described in conjunction with the following drawing figures, wherein like numerals denote like elements, and wherein:

FIG. 1 is a functional block diagram of a system that includes a vehicle and a trailer, with coordinated park braking for the vehicle and the trailer, in accordance with an exemplary embodiment; and

FIG. 2 is a flowchart of a process for coordinated braking between a trailer and a vehicle, such as the trailer and vehicle of FIG. 1, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

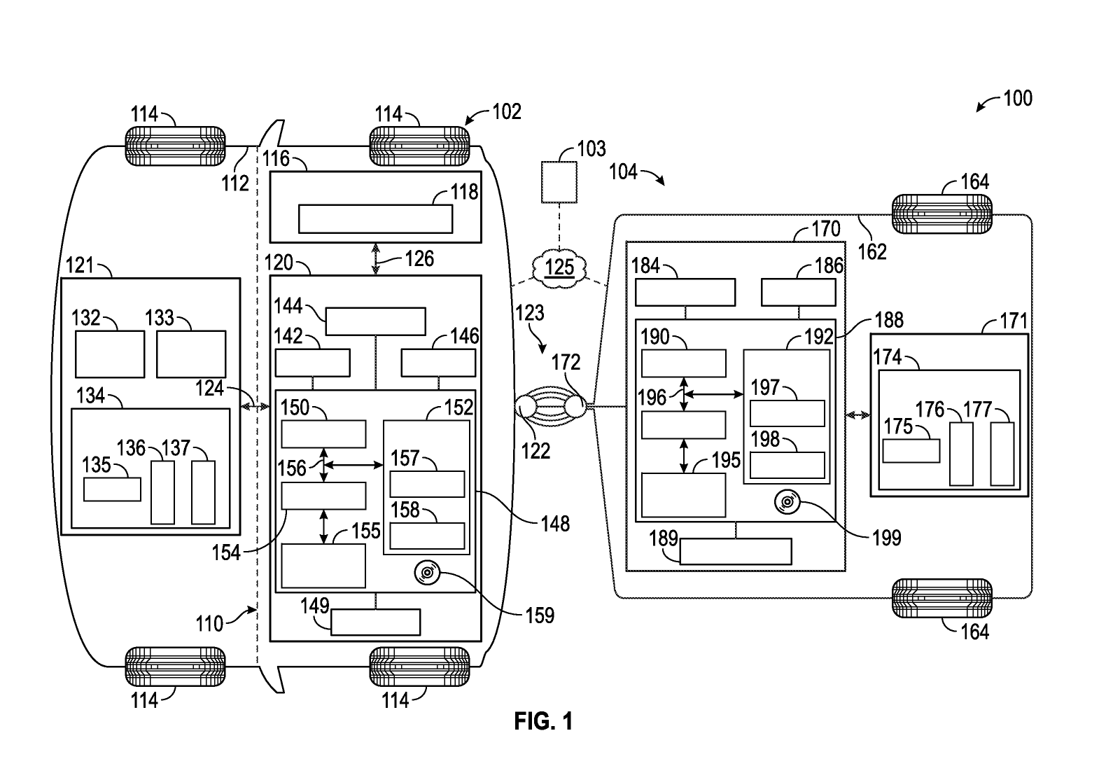

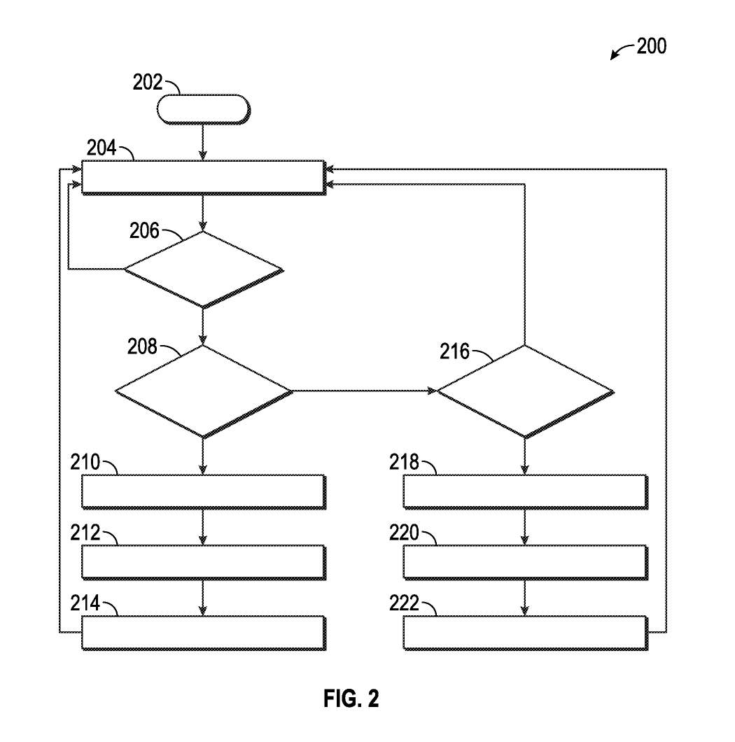

FIG. 1 illustrates a system 100 that includes a vehicle 102 and a trailer 104. As depicted in FIG. 2, the vehicle 102 and the trailer 104 are connected together via respective connectors 122, 172 and associated connecting wires 123, so that the trailer 104 moves along with the vehicle 102 as the vehicle 102 is driven.

It will be appreciated that the vehicle 102 and trailer 104 may comprise any one or more of a number of different types of vehicles and trailers, respectively. For example, the vehicle 102 may be any one of a number of different types of automobiles and/or other vehicle types. For example, in various embodiments, the vehicle 102 may comprise a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or any one of a number of other types of vehicles. Similarly, the trailer 104 may be any one of a number of different types of trailers pulled and/or transported by such a vehicle 102, including, by way of example only, trailers used to transport other automobiles, boats or other marine vehicles, other vehicles, cargo, and/or other devices and/or systems.

As described in greater detail further below, the vehicle 102 and the trailer 104 include respective control systems 120, 170 for the vehicle 102 and the trailer 104. Specifically, as discussed further below, the control systems 120, 170 allow for parking brake capability for the trailer 104 in tandem with the vehicle 102 via the respective braking systems 121, 171 of the trailer 104 and the vehicle 102.

As depicted in FIG. 1, the vehicle 102 includes, in addition to the above-referenced control system 120, a chassis 110, a body 112, four wheels 114, and a braking system 121. The body 112 is arranged on the chassis 110 and substantially encloses the other components of the vehicle 102. The body 112 and the chassis 110 may jointly form a frame. The wheels 114 are each rotationally coupled to the chassis 110 near a respective corner of the body 112. In various embodiments the vehicle 102 may differ from that depicted in FIG. 1. For example, in certain embodiments the number of wheels 114 may vary.

The propulsion system 116 powers the vehicle 102 via movement of the wheels 114. In various embodiments, the propulsion system 116 is part of an actuator assembly for powering movement of the vehicle. In one embodiment, the propulsion system 116 is mounted on the chassis 110, and drives the wheels 114.

In the depicted embodiment, the propulsion system 116 includes a motor and/or engine 118. In one embodiment, the motor/engine 118 comprises an electric motor/generator that is powered by a rechargeable energy storage system (RESS) (e.g., a vehicle battery) (not depicted). In another embodiment, the motor/engine 118 comprises a gasoline combustion engine. In other embodiments, the motor/engine 118 may include one or more other of these and/or other types of engines and/or motors. The motor/engine 118 is coupled to at least some of the wheels 114 through one or more drive shafts (not depicted). In some embodiments, the motor/engine 118 is mechanically coupled to the transmission. In other embodiments, the motor/engine 118 may instead be coupled to a generator used to power an electric motor that is mechanically coupled to the transmission. In certain other embodiments (e.g. electrical vehicles), an engine and/or transmission may not be necessary.

The braking system 121 is mounted on the chassis 110, and provides braking for the vehicle 102. As depicted in FIG. 1, the braking system 121 includes a brake pedal 132, parking brake input devices 133, and a parking brake 134. The braking system 121 receives braking inputs from the driver via a brake pedal 132 as well as one or more parking brake input devices 133. Specifically, in one embodiment, the brake pedal 132 receives braking inputs from the driver during operation of the vehicle 102. Also in one embodiment, the parking brake input devices 133 (e.g. one or more parking brake pedals, switches, levels, and/or the like) receive requests from a driver for engagement and/or release of the parking brake 134. Also as depicted in FIG. 1, the parking brake 134

Also as depicted in FIG. 1, the parking brake 134 includes a cable 135, brake pads 136, and brake discs 137. In one embodiment, when the parking brake 134 is engaged, tension is maintained in the cable 135 via one or more actuators 149 (described further below), thereby causing the brake pads 136 to be in contact with the braking discs 137, providing parking braking for the vehicle 102. Also in one embodiment, when the parking brake 134 is released, tension is released for the cable 135 via the one or more actuators 149, thereby causing the brake pads 136 to no longer be in contact with the braking discs 137, thereby terminating parking braking for the vehicle 102. It will be appreciated that the parking brake 134 may be engaged and/or released in one or more different manners in other embodiments. It will also be appreciated that the brake pads 136 are also engaged when non-parking braking is requested, for example via the driver's engagement of the brake pedal 132.

As noted above, the control system 120 facilitates control of communication with the trailer 104 and parking braking capability for the trailer 104 in tandem with the vehicle 102 via the respective braking systems 121, 171 of the trailer 104 and the vehicle 102, via communications with the control system 170 of the trailer 104 for implementation with the trailer 104. Specifically, when the parking brake 134 of the vehicle 102 is engaged, the control system 120 of the vehicle 102 provides instructions to the control system 170 of the trailer 104 to engage the parking brake 174 of the trailer 104 in tandem with the engagement of the parking brake 134 of the vehicle 102. Likewise, when the parking brake 134 of the vehicle 102 is released, the control system 120 of the vehicle 102 provides instructions to the control system 170 of the trailer 104 to release the parking brake 174 of the trailer 104 in tandem with the release of the parking brake 134 of the vehicle 102.

In addition, in various embodiments, the control system 120 also facilitates control over the propulsion system 116 and the braking system 121 of the vehicle 102, among various other vehicle systems and modules (e.g. steering, environmental control, active safety, infotainment, and so on). In various embodiments, the control system 120 facilitates such control via communications along a vehicle bus 124 and/or other communication networks, devices, and/or systems of the vehicle 102. In one embodiment, the control system 120 is part of, and/or controls, in whole or in part, a control system for the propulsion system 116 (e.g. comprising an engine control system, or “ECS”).

Also as noted above, the vehicle connector 122 physically connects the vehicle 102 with the trailer 104 via a connection between the vehicle connector 122 and the trailer connector 172 of FIG. 1 via various wires 123. In one embodiment, six wires 123 are utilized to connect the vehicle 102 and the trailer 104. However, the number of wires 123 may vary in other embodiments. Also in one embodiment: (i) a first wire 123 is used for running lights of the trailer 104; (ii) a second wire 123 is an auxiliary wire between the vehicle 102 and the trailer 104; (iii) a third wire 123 is used for controlling right turns and stops for the trailer 104; (iv) a fourth wire 123 is used for controlling electric brakes of the trailer 104 (as part of the braking system 171 of the trailer 104, discussed below); (v) a fifth wire 123 is used as a ground between the vehicle 102 and the trailer 104; and (vi) a sixth wire 123 is used for left turns and stops for the trailer 104. The function and/or arrangement of the wires 123 may also differ in various embodiments.

With reference again to the control system 120, in one embodiment the control system 120 is mounted on the chassis 110. Also in one embodiment, the control system 120 comprises a modem 142, a transceiver 144, various sensors 146, a controller 148, and one or more actuators 149. In various embodiments, the control system 120, among other features, facilitates communications with the trailer 104, and parking braking capability for the trailer 104 in tandem with the vehicle 102 via the respective braking systems 121, 171 of the trailer 104 and the vehicle 102, for example in accordance with the steps of the process 200 described further below in connection with FIG. 2.

In various embodiments, the modem 142 facilitates communications with the trailer 104 as well as the dissemination of information (including information from the trailer 104, such as regarding parking brake capabilities and/or operation and/or other trailer 104 capabilities and/or operation and/or trailer 104 parking brake status) throughout the vehicle 102. In one embodiment, the modem 142 comprises a power line communication (PLC) modem that is coupled between the vehicle bus 124 and the controller 148. Also in one embodiment, the modem 142 disseminates information throughout the vehicle 102 along the vehicle bus 124. In addition, in one embodiment, the modem 142 facilitates communications with the trailer 104 along with the transceiver 144. In various embodiments, the modem 142 performs these and other functions in facilitating communications with the trailer 104, among other features, for example in accordance with the steps of the process 200 described further below in connection with FIG. 2. Also in one embodiment, the trailer parking brake status is saved and maintained in the memory 152 in the trailer control system 170 or a potential sensor within the trailer braking system 171 for the purpose of providing feedback to the vehicle about trailer parking brake application, so that the driver can “release” the trailer parking brake before commencing any propulsion maneuvers after coupling is completed.

In various embodiments, the transceiver 144 also facilitates communications with the trailer 104, for example in concert with a respective transceiver 184 of the trailer 104. In various embodiments, the transceiver 144 may comprise any number of receivers, transmitters, and/or transceivers. In various embodiments, the transceiver 144 transmits information from the vehicle 102 to the trailer 104, for example including instructions from the processor 150 of FIG. 1 for operation and/or control for the trailer 104, including engagement and release of the parking brake 174 of the trailer 104. In addition, in certain embodiments, the transceiver 144 may also facilitate dissemination of information (including information from the trailer 104, such as regarding parking brake capabilities and/or operation and/or other trailer 104 capabilities and/or operation and/or trailer 104 parking brake status) throughout the vehicle 102. In certain embodiments, the transceiver 144 communicates with the transceiver 184 of the trailer 104 via a wired connection, for example via one or more of the wires 123. In other embodiments, the transceiver 144 communicates with the transceiver 184 communicates with the transceiver 184 of the trailer 104, wirelessly, for example via a wireless network 125 as depicted in FIG. 1. In one embodiment, the wireless network 125 comprises s cellular wireless communication network. In another embodiment, the wireless network 125 comprises a short-range wireless (e.g. Bluetooth) communication network. In other embodiments, a combination of such wireless networks may be used, and/or one or more other different types of wireless networks may be used. In yet other embodiments, the transceivers 144 and 184 may communicate both via one or more wired connections and via one or more wireless networks. In certain embodiments, the transceiver 184 may communicate the information (including information regarding the parking braking of the trailer 104) via one or more wireless devices 103, for example a smart phone, tablet, computer, and/or other electronic device of a driver and/or other user of the vehicle 102, via one or more wireless networks 125 (which may be the same or different as the wireless network(s) used to communicate with the vehicle 102). In various embodiments, the transceiver 144 performs these and other features in accordance with the steps of the process 200 described further below in connection with FIG. 2.

In various embodiments, the sensors 146 measure and/or obtain information pertaining to one or more devices, systems, and/or components of the vehicle 102, including with respect to the braking system 121 of the vehicle. For example, in certain embodiments, the sensors 146 may include braking input sensors for measuring user inputs as to braking (e.g. via brake pedal position, travel, and/or force sensors), parking brake input sensors (e.g. parking brake pedal, switch, lever, and/or other device sensors) for measuring or detecting a driver's request to engage and/or release the parking brake(s) 137, 174, and/or one or more other types of inputs. In various embodiments, the sensors 146 may also include one or more other types of sensors, such as, by way of example only, brake cable sensors, brake pad sensors, brake disc sensors, wheel speed sensors, accelerometers, impact sensors, and/or one or more other types of sensors 146 that may be used in controlling the braking systems 121, 171 and/or one or more other systems and/or modules of the vehicle 102 and/or the trailer 104. In various embodiments, the sensors 146 perform these and other functions in facilitating communications with the trailer 104, among other features, for example in accordance with the steps of the process 200 described further below in connection with FIG. 2.

The actuators 149 are configured to facilitate operation of the parking brake 134 of the braking system 121 of the vehicle 102. In one embodiment, the actuators 149 provide tension for the cable 135, via instructions provided by the controller 148 (e.g. via the processor 150 thereof) when engagement of the parking brake 134 is requested. Also in one embodiment, the actuators 149 release tension for the cable 135, via instructions provided by the controller 148 (e.g. via the processor 150 thereof) when release of the parking brake 134 is requested.

The controller 148 is coupled to the modem 142, the transceiver 144, the sensors 146, and the actuators 149. The controller 148 controls communication with the trailer 104, and controls use of the parking brake 174 of the trailer 104 in tandem with the parking brake 134 of the vehicle 102. In addition, in certain embodiments, the controller 148 also utilizes information obtained from the trailer 104, along with information obtained from the modem 142, the transceiver 144, and the sensors 146, in controlling various systems and modules for the vehicle 102, such as the propulsion system 116, and/or for the trailer 104. In various embodiments, the controller 148 performs these and other functions in facilitating communications with the trailer 104, among other features, for example in accordance with the steps of the process 200 described further below in connection with FIG. 2.

As depicted in FIG. 1, the controller 148 comprises a computer system. In certain embodiments, the controller 148 may also include one or more of the modem 142, transceiver 144, sensors 146, one or more other devices and/or systems, and/or components thereof. In addition, it will be appreciated that the controller 148 may otherwise differ from the embodiment depicted in FIG. 1. For example, the controller 148 may be coupled to or may otherwise utilize one or more remote computer systems and/or other control systems, and/or one or more other systems of the vehicle 102.

In the depicted embodiment, the computer system of the controller 148 includes a processor 150, a memory 152, an interface 154, a storage device 155, and a bus 156. The processor 150 performs the computation and control functions of the controller 148, and may comprise any type of processor or multiple processors, single integrated circuits such as a microprocessor, or any suitable number of integrated circuit devices and/or circuit boards working in cooperation to accomplish the functions of a processing unit. During operation, the processor 150 executes one or more programs 157 contained within the memory 152 and, as such, controls the general operation of the controller 148 and the computer system of the controller 148, generally in executing the processes described herein, such as the process 200 described further below in connection with FIG. 2.

The memory 152 can be any type of suitable memory. For example, the memory 152 may include various types of dynamic random access memory (DRAM) such as SDRAM, the various types of static RAM (SRAM), and the various types of non-volatile memory (PROM, EPROM, and flash). In certain examples, the memory 152 is located on and/or co-located on the same computer chip as the processor 150. In the depicted embodiment, the memory 152 stores the above-referenced program 157 along with one or more stored values 158. Also in one embodiment, the trailer parking brake status is saved and maintained in the memory 152.

The bus 156 serves to transmit programs, data, status and other information or signals between the various components of the computer system of the controller 148. The interface 154 allows communication to the computer system of the controller 148, for example from a system driver and/or another computer system, and can be implemented using any suitable method and apparatus. In one embodiment, the interface 154 obtains the various data from the sensors of the sensors 146. The interface 154 can include one or more network interfaces to communicate with other systems or components. The interface 154 may also include one or more network interfaces to communicate with technicians, and/or one or more storage interfaces to connect to storage apparatuses, such as the storage device 155.

The storage device 155 can be any suitable type of storage apparatus, including direct access storage devices such as hard disk drives, flash systems, floppy disk drives and optical disk drives. In one exemplary embodiment, the storage device 155 comprises a program product from which memory 152 can receive a program 157 that executes one or more embodiments of one or more processes of the present disclosure, such as the steps of the process 200 (and any sub-processes thereof) described further below in connection with FIG. 2. In another exemplary embodiment, the program product may be directly stored in and/or otherwise accessed by the memory 152 and/or a disk (e.g., disk 159), such as that referenced below.

The bus 156 can be any suitable physical or logical means of connecting computer systems and components. This includes, but is not limited to, direct hard-wired connections, fiber optics, infrared and wireless bus technologies. During operation, the program 157 is stored in the memory 152 and executed by the processor 150.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 150) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 148 may also otherwise differ from the embodiment depicted in FIG. 1, for example in that the computer system of the controller 148 may be coupled to or may otherwise utilize one or more remote computer systems and/or other control systems.

While the components of the control system 120 (including the modem 142, the transceiver 144, the sensors 146, and the controller 148) are depicted as being part of the same system, it will be appreciated that in certain embodiments these features may comprise two or more systems. In addition, in various embodiments the control system 120 may comprise all or part of, and/or may be coupled to, various other vehicle devices and systems, such as, among others, the propulsion system 116, one or more of the other systems and/or modules of the vehicle 102.

Also as depicted in FIG. 1, the trailer 104 includes, in addition to the above-referenced control system 170, the braking system 171, and the connector 172, a body 162 and a plurality of wheels 164. In one embodiment, the body 162 substantially encloses the other components of the trailer 104. In various embodiments the trailer 104 may differ from that depicted in FIG. 1. For example, in certain embodiments the number of wheels 164 may vary.

As noted above, the control system 170 facilitates control of communication with the vehicle 102 and implements instructions provided from the vehicle 102 via the respective control system 120 of the vehicle 102, including for engagement and release of the parking brake 174 of the trailer 104 in tandem with the parking brake 134 of the vehicle 102, for example in accordance with the steps of the process 200 of FIG. 2. Also as noted above, the trailer connector 172 physically connects the trailer 104 with the vehicle 102 via a connection between the vehicle connector 122 and the trailer connector 172 of FIG. 1 via various wires 123, and also as described in greater detail above. In various embodiments the control system 170 is disposed onboard, and integrated with, the trailer 104.

As depicted in FIG. 1, the control system 170 comprises a transceiver 184, various sensors 186, a controller 188, and one or more actuators 189. In addition to facilitating control of communications with the vehicle 102, the control system 170 also facilitates control over the braking system 171 of the trailer 104 (along with other possible systems and/or modules of the trailer 104), for example via instructions provided from the vehicle control system 120 to the trailer control system 170 for implementation with the trailer 104. Specifically, when the parking brake 134 of the vehicle 102 is engaged, the control system 170 of the trailer 104 implements instructions from the control system 120 of the vehicle 102 to engage the parking brake 174 of the trailer 104 in tandem with the engagement of the parking brake 134 of the vehicle 102. Likewise, when the parking brake 134 of the vehicle 102 is released, the control system 170 of the trailer 104 implements instructions from the control system 120 of the vehicle 102 to release the parking brake 174 of the trailer 104 in tandem with the release of the parking brake 134 of the vehicle 102. Further, in one embodiment, when a detection is made of the trailer parking brake being applied when the vehicle parking brake is not, the system will detect and announce the lack of coordination to the driver such that they can release the trailer parking brake through the reuse of the vehicle's parking brake control input. In addition, in one embodiment, vehicle braking and propulsion systems may trigger the application/release of the trailer parking brake without the driver's intervention.

The braking system 171 controls braking of the trailer 104 via instructions provided via the controllers 148 and/or 188, for example as described above. As depicted in FIG. 1, the braking system 171 includes a parking brake 174 that includes a cable 175, brake pads 176, and brake discs 177. In one embodiment, when the parking brake 174 is engaged (e.g. via instructions via the controllers 148 and/or 188 for engagement of the parking brake 174 in tandem with the engagement of the vehicle parking brake 134), tension is maintained in the cable 175 via the one or more actuators 189, thereby causing the brake pads 176 to be in contact with the braking discs 137, providing parking braking for the trailer 104. Similarly, also in one embodiment, when the parking brake 174 is released (e.g. via instructions via the controllers 148 and/or 188 for release of the parking brake 174 in tandem with the release of the vehicle parking brake 134), tension is released for the cable 175 via the one or more actuators 189, thereby causing the brake pads 176 to no longer be in contact with the braking discs 137, thereby releasing parking braking for the trailer 104. It will be appreciated that the parking brake 134 may be engaged and/or released in one or more different manners in other embodiments. It will also be appreciated that the brake pads 176 may also be engaged when non-parking braking is requested, for example via instructions provided via the controllers 148 and/or 188 in response to the driver's engagement of the brake pedal 132 of the vehicle 102.

With reference back to the control system 170, the transceiver 184 facilitates communications with the vehicle 102, for example in concert with the respective transceiver 144 of the vehicle 102. Specifically, in one embodiment, the transceiver 184 receives instructions from the vehicle 102 for engagement and/or release of the parking brake 174 of the trailer 104 in tandem with the parking brake 134 of the vehicle 102. In various embodiments, the transceiver 184 may comprise any number of receivers, transmitters, and/or transceivers. In certain embodiments, the transceiver 184 also communicates various types of trailer information, such as parking brake 174 configuration and/or operation, and/or other trailer 104 configuration and/or operation information, to the vehicle 102. In certain embodiments, the transceiver 184 communicates with the transceiver 144 of the vehicle 102 via a wired connection, for example via one or more of the wires 123. In other embodiments, the transceiver 184 communicates with the transceiver 144 communicates with the transceiver 144 of the vehicle 102, wirelessly, for example via a wireless network 125 as depicted in FIG. 1. In yet other embodiments, the transceivers 184 and 144 may communicate both via one or more wired connections and via one or more wireless networks.

In various embodiments, the sensors 186 measure and/or obtain information pertaining to one or more devices, systems, and/or components of the trailer 104. For example, in certain embodiments, the sensors 186 may include one or more connection sensors for detecting when the trailer 104 is connected to the vehicle 102 via connectors 122, 172, one or more brake sensors for measuring a position or operation of brake units of the braking system 171, one or more parking brake sensors for measuring engagement or release of the parking brake 174 of the trailer 104, one or more wheel sensors measuring position or movement of the wheels 164, and/or one or more other types of measurements pertaining to the trailer 104 and/or the operation thereof

The actuators 189 are configured to facilitate operation of the parking brake 174 of the braking system 171 of the trailer 104. In one embodiment, the actuators 189 provide tension for the cable 175, via instructions provided by the controller 188 (e.g. via the processor 190 thereof) when engagement of the parking brake(s) 134, 174 is requested. Also in one embodiment, the actuators 189 release tension for the cable 175, via instructions provided by the controller 188 (e.g. via the processor 190 thereof) when release of the parking brake(s) 134, 174 is requested.

The controller 188 is coupled to the transceiver 184, the sensors 186, and the actuators 189. The controller 188 controls communication with the vehicle 102, including the implementation of instructions from the controller 148 of the vehicle 102 in controlling the parking brake 174 of the trailer 104 in tandem with the parking brake 134 of the vehicle 102. In addition, in certain embodiments, the controller 188 also facilitates the transmission of the trailer-related information to the vehicle 102 (e.g. pertaining to configuration and/or operation of the parking brake 174, the braking system 171 in general, and/or other systems and/or modules of the trailer 104).

As depicted in FIG. 1, the controller 188 comprises a computer system. In certain embodiments, the controller 188 may also include one or more of the transceiver 184, sensors 186, one or more other devices and/or systems, and/or components thereof. In addition, it will be appreciated that the controller 188 may otherwise differ from the embodiment depicted in FIG. 1. For example, the controller 188 may be coupled to or may otherwise utilize one or more remote computer systems and/or other control systems, and/or one or more other systems of the trailer 104.

In the depicted embodiment, the computer system of the controller 188 includes a processor 190, a memory 192, an interface 194, a storage device 195, and a bus 196. The processor 190 performs the computation and control functions of the controller 188, and may comprise any type of processor or multiple processors, single integrated circuits such as a microprocessor, or any suitable number of integrated circuit devices and/or circuit boards working in cooperation to accomplish the functions of a processing unit. During operation, the processor 190 executes one or more programs 197 contained within the memory 192 and, as such, controls the general operation of the controller 188 and the computer system of the controller 188, generally in executing the processes described herein, such as the process 200 described further below in connection with FIG. 2.

The memory 192 can be any type of suitable memory. For example, the memory 192 may include various types of dynamic random access memory (DRAM) such as SDRAM, the various types of static RAM (SRAM), and the various types of non-volatile memory (PROM, EPROM, and flash). In certain examples, the memory 192 is located on and/or co-located on the same computer chip as the processor 190. In the depicted embodiment, the memory 192 stores the above-referenced program 197 along with one or more stored values 198 (e.g. various pertaining to the trailer 104, for example pertaining to configuration and/or operation of the braking system 171).

The bus 196 serves to transmit programs, data, status and other information or signals between the various components of the computer system of the controller 188. The interface 194 allows communication to the computer system of the controller 188, for example from a system driver and/or another computer system, and can be implemented using any suitable method and apparatus. In one embodiment, the interface 194 obtains the various data from the sensors of the sensors 186. The interface 194 can include one or more network interfaces to communicate with other systems or components. The interface 194 may also include one or more network interfaces to communicate with technicians, and/or one or more storage interfaces to connect to storage apparatuses, such as the storage device 195.

The storage device 195 can be any suitable type of storage apparatus, including direct access storage devices such as hard disk drives, flash systems, floppy disk drives and optical disk drives. In one exemplary embodiment, the storage device 195 comprises a program product from which memory 192 can receive a program 197 that executes one or more embodiments of one or more processes of the present disclosure, such as the steps of the process 200 (and any sub-processes thereof) described further below in connection with FIG. 2. In another exemplary embodiment, the program product may be directly stored in and/or otherwise accessed by the memory 192 and/or a disk (e.g., disk 199), such as that referenced below.

The bus 196 can be any suitable physical or logical means of connecting computer systems and components. This includes, but is not limited to, direct hard-wired connections, fiber optics, infrared and wireless bus technologies. During operation, the program 197 is stored in the memory 192 and executed by the processor 190.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 190) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 188 may also otherwise differ from the embodiment depicted in FIG. 1, for example in that the computer system of the controller 188 may be coupled to or may otherwise utilize one or more remote computer systems and/or other control systems.

While the components of the control system 170 (including the transceiver 184, the sensors 186, and the controller 188) are depicted as being part of the same system, it will be appreciated that in certain embodiments these features may comprise two or more systems. In addition, in various embodiments the control system 170 may comprise all or part of, and/or may be coupled to, various other trailer devices and systems, such as, among others, the braking system 171 of the trailer 104.

FIG. 2 is a flowchart of a process 200 for controlling a parking brake, in accordance with an exemplary embodiment. In one embodiment, the process 200 controls a parking brake for a trailer that is connected to a vehicle. In another embodiment, the parking brake for the trailer is controlled via a signal or command from a wireless device (e.g. from a computer, smart phone, or other device of a user of the vehicle and/or the trailer). The process 200 can be implemented in connection with the vehicle 102 and the trailer 104 of FIG. 1, in accordance with an exemplary embodiment.

As depicted in FIG. 2, in one embodiment, the process 200 begins at step 202. In one embodiment, the process 200 begins when a driver is disposed within a vehicle, for example when the driver is seated in the vehicle and/or ready to operate the vehicle.

Inputs are obtained (step 204). In one embodiment, the inputs comprise driver inputs that include inputs made by the driver of the vehicle with respect to the parking brake interface 133 of FIG. 1, and that are measured and/or detected via one or more sensors 146 of FIG. 1 that are part of or coupled to the parking brake interface 133 (e.g. sensors associated with a parking brake pedal, a parking brake switch, a parking brake lever, and so on). In various other embodiments, other driver inputs may also be obtained (e.g. with respect to the brake pedal 132 of FIG. 1, an accelerator pedal, a steering wheel, a navigation unit, a climate control system, an infotainment unit, and so on). In other embodiments, the inputs may be obtained from one or more vehicle systems, and/or from one or more wireless devices (e.g. from a computer, smart phone, or other device of a user of vehicle and/or the trailer).

A determination is made as to whether a parking brake request has been received (step 206). In one embodiment, step 206 comprises a determination, based on the driver inputs of step 204, as to whether the driver is requesting an engagement or release of the parking brake 134 of FIG. 1. In one embodiment, this determination is made by the processor 150 of FIG. 1. In another embodiment, the determination of step 206 comprises a determination (e.g. by the processor 150 of FIG. 1) as to whether a parking brake request has been made by one or more vehicle systems. In yet another embodiment, the determination of step 206 comprises a determination (e.g. by the processor 150 of FIG. 1) as to whether a parking brake request has been made via one or more wireless devices (e.g. from a computer, smart phone, or other device of a user of vehicle and/or the trailer).

If it is determined in step 206 that a parking brake request has been received, a determination is made as to whether the parking brake request comprises a request to engage the parking brake (step 208). In one embodiment, this determination is made by the processor 150 of FIG. 1. Conversely, if no parking brake request has been received, the process instead returns to step 204.

If it is determined in step 208 that a request has been received to engage the parking brake (e.g. the parking brake 134), then the parking brake 134 of the vehicle 102 of FIG. 1 is engaged (step 210). Similar to the discussion above, in one embodiment, the processor 150 provides instructions for the actuators of FIG. 1 to automatically provide and maintain tension for the cable 135, so that the brake pads 136 are in contact with the brake discs 137 of FIG. 1.

In addition, signals are provided to the trailer with regard to engagement of the park brake of the trailer (step 212). In one embodiment, the signals are transmitted via the transceiver 144 of FIG. 1 via instructions provided by the processor 150 of FIG. 1, and are received via the transceiver 184 of FIG. 1.

The parking brake of the trailer is engaged (step 214). In one embodiment, the parking brake 174 of the trailer 104 is engaged via implementation of the instructions of step 212, via the processor 190 of the trailer in providing corresponding instructions to the actuators 189 of FIG. 1. Specifically, in one embodiment, the processor 190 issues instructions (based on instructions provided via the processor 150) for the actuators 189 to automatically provide and maintain tension for the cable 175, so that the brake pads 176 are in contact with the brake discs 177 of FIG. 1. Accordingly, the parking brake 134 of the trailer 104 is engaged in tandem with, and at the same time as, the parking brake 134 of the vehicle 102. In one embodiment, the determination of step 214 includes tracking a status of the trailer parking brake as part of step 214, or through a confirmation through an applicable sensor of the trailer braking system 171, and includes such detection and reporting that the trailer parking brake has been applied to the driver.

Conversely, if it is determined in step 208 that the parking brake request does not comprise a request to engage the parking brake, then a determination is made as to whether the parking brake request comprises a request to release the parking brake (step 216). In one embodiment, this determination is made by the processor 150 of FIG. 1. In one embodiment, the determination of step 216 comprises a determination as to whether a user of the vehicle has requested a release of the parking brake. In another embodiment, the determination of step 216 comprises a determination (e.g. by the processor 150 of FIG. 1) as to whether a parking brake release request has been made by one or more vehicle systems. In yet another embodiment, the determination of step 216 comprises a determination (e.g. by the processor 150 of FIG. 1) as to whether a parking brake release request has been made via one or more wireless devices (e.g. from a computer, smart phone, or other device of a user of vehicle and/or the trailer).

If it is determined in step 216 that a request has been received to release the parking brake (e.g. the parking brake 134), then the parking brake 134 of the vehicle 102 of FIG. 1 is released (step 218). In one embodiment, the processor 150 provides instructions for the actuators of FIG. 1 to automatically release tension for the cable 135, so that the brake pads 136 are no longer in contact with the brake discs 137 of FIG. 1.

In addition, signals are provided to the trailer with regard to release of the park brake of the trailer (step 220). In one embodiment, the signals are transmitted via the transceiver 144 of FIG. 1 via instructions provided by the processor 150 of FIG. 1, and are received via the transceiver 184 of FIG. 1. In one embodiment, the determination of step 220 is satisfied upon a further confirmation (e.g. via data provided via one or more applicable sensors) that either the vehicle gear selected is park or that the vehicle service brakes 132 are applied before issuing the trailer parking brake release command from the vehicle 102 to the trailer 104.

The parking brake of the trailer is released (step 214). In one embodiment, the parking brake 174 of the trailer 104 is released via implementation of the instructions of step 212, via the processor 190 of the trailer in providing corresponding instructions to the actuators 189 of FIG. 1. Specifically, in one embodiment, the processor 190 issues instructions (based on instructions provided via the processor 150) for the actuators 189 to automatically release tension for the cable 175, so that the brake pads 176 are no longer in contact with the brake discs 177 of FIG. 1. Accordingly, in one embodiment, the parking brake 134 of the trailer 104 is released in tandem with, and at the same time as, the parking brake 134 of the vehicle 102, subject to the confirmation that either the vehicle gear selected is park or that the vehicle service brakes 132 are applied before issuing the trailer parking brake release command from the vehicle 102 to the trailer 104.

Conversely, if it is determined in step 216 that a request has not been made to release the parking brake, then the process proceeds instead to step 204. Accordingly, the process proceeds step 204, instead of steps 210 or 218, when a request is not made to engage or release the parking brake. It will be appreciated that while steps 206, 208, and 216 are presented in FIG. 2 as three determinations, it will be appreciated that the number of determinations may vary. For example, in one embodiment, steps 206, 208, and/or 216 could be presented as one or two combined steps, with substantively the same results.

Accordingly, methods and systems are provided for controlling braking for a trailer that is connected to a vehicle. The disclosed methods and systems provide for the engagement and release of a parking brake for the trailer in tandem with that of a parking brake for the vehicle that is attached to the trailer. As a result, this can make the secure parking of the trailer easier and more convenient for the driver or other user, for example by automatically engaging and releasing the trailer parking brake in tandem with that of the vehicle parking brake. In addition, this can reduce or eliminate the need for separate manual operation of brakes for the trailer, as well as reduce or eliminate the need for cinder or other blocs to be manually inserted against the trailer wheels when the vehicle and the trailer are parked together. Moreover, this can also provide theft deterrence when the vehicle and trailer are parked together. In one embodiment, the application of the trailer parking brake using this method would mean the parking brake remains applied after the vehicle has been decoupled from the towing vehicle. Also in one embodiment, not until an appropriate command is provided through the vehicle trailer interface to release the trailer parking brake would the parking brake be released thus providing a theft deterrent strategy when the trailer is left parked decoupled from the towing vehicle.

It will be appreciated that the disclosed methods and systems may vary from those depicted in the Figures and described herein. For example, the vehicle 102, the trailer 104, the respective control systems 120, 170, and/or various components thereof may vary from that depicted in FIG. 1 and described in connection therewith. In addition, it will be appreciated that certain steps of the process 200 may vary from those depicted in FIG. 2 and/or described above in connection therewith. It will similarly be appreciated that certain steps of the methods described above may occur simultaneously or in a different order than that depicted in FIG. 2 and/or described above in connection therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the appended claims and the legal equivalents thereof

What is claimed is:

1. A system comprising:
a parking brake configured to be installed on a trailer that is configured to be connected to a vehicle;
an actuator coupled to the parking brake; and
a processor configured to be installed on the trailer, the processor configured to cause the actuator to engage the parking brake in accordance with engagement instructions provided from the vehicle to the trailer.

2. The system of claim 1, wherein the processor is configured to cause the actuator to release the parking brake in accordance with release instructions provided from the vehicle to the trailer.

3. The system of claim 2, wherein the processor is configured to cause the actuator to:
engage the parking brake of the trailer in tandem with a respective engagement of a separate parking brake of the vehicle; and
release the parking brake of the trailer in tandem with a respective release of the separate parking brake of the vehicle.

4. The system of claim 2, wherein the processor is configured to cause the actuator to:
engage the parking brake of the trailer when a driver of the vehicle or the vehicle braking system requests parking brake engagement; and
release the parking brake of the trailer when the driver of the vehicle or the vehicle braking system requests parking brake release.

5. The system of claim 2, wherein the parking brake comprises:
one or more brake pads;
one or more brake discs; and
a cable that is configured to:
receive tension via the actuator, to thereby cause the brake pads to contact the brake discs, when the engagement instructions are provided form the vehicle to the trailer; and
have tension released via the actuator, to thereby cause the brake pads to no longer contact the brake discs, when the release instructions are provided form the vehicle to the trailer.

6. The system of claim 2, further comprising:
a transceiver coupled to the processor and configured to receive the engagement instructions and the release instructions from the vehicle.

7. The system of claim 6, wherein the transceiver is configured to receive the engagement instructions and the release instructions from the vehicle via a wired connection.

8. The system of claim 6, wherein the transceiver is configured to receive the engagement instructions and the release instructions from the vehicle via a wireless connection.

9. A trailer comprising:
a connector configured to connect the trailer to a vehicle;
a parking brake disposed onboard the trailer;
an actuator coupled to the parking brake; and
a processor configured to cause the actuator to engage the parking brake in accordance with engagement instructions provided from the vehicle to the trailer.

10. The trailer of claim 9, wherein the processor is configured to cause the actuator to control the parking brake in accordance with control instructions provided from the vehicle to the trailer.

11. The trailer of claim 10, wherein the processor is configured to cause the actuator to:
engage the parking brake of the trailer in tandem with a respective engagement of a separate parking brake of the vehicle; and
release the parking brake of the trailer in tandem with a respective release of the separate parking brake of the vehicle.

12. The trailer of claim 10, wherein the processor is configured to cause the actuator to:
engage the parking brake of the trailer when a driver of the vehicle or the vehicle braking system requests parking brake engagement; and
release the parking brake of the trailer when the driver of the vehicle or the vehicle braking system requests parking brake release.

13. The trailer of claim 10, wherein the parking brake comprises:
one or more brake pads;
one or more brake discs; and
a cable that is configured to:
receive tension via the actuator, to thereby cause the brake pads to contact the brake discs, when the engagement instructions are provided form the vehicle to the trailer; and
have tension released via the actuator, to thereby cause the brake pads to no longer contact the brake discs, when the release instructions are provided form the vehicle to the trailer.

14. The trailer of claim 10, further comprising:
a transceiver coupled to the processor and configured to receive the engagement instructions and the release instructions from the vehicle.

15. The trailer of claim 14, wherein the transceiver is configured to receive the engagement instructions and the release instructions from the vehicle via a wired connection.

16. The trailer of claim 14, wherein the transceiver is configured to receive the engagement instructions and the release instructions from the vehicle via a wireless connection.

17. A method comprising:
receiving engagement instructions from a vehicle to a trailer for engagement of a parking brake of the trailer, wherein the trailer is connected to the vehicle; and
in response to the engagement instructions, causing an actuator on the trailer to engage a parking brake of the trailer in tandem with a separate parking brake of the vehicle.

18. The method of claim 17, further comprising:
receiving release instructions from the vehicle to the trailer for release of the parking brake of the trailer; and
in response to the release instructions, causing the actuator to release the parking brake of the trailer in tandem with the separate parking brake of the vehicle.

19. The method of claim 18, wherein the engagement instructions and the release instructions are received at the trailer via a wired connection with the vehicle.

20. The method of claim 18, wherein the engagement instructions and the release instructions are received at the trailer via a wireless connection with the vehicle.
